(19) United States
(12) Patent Application Publication
(10) Pub. No.: US 2024/0210170 A1
(43) Pub. Date: Jun. 27, 2024

(54) METHOD FOR TRACKING AND MONITORING A SCAN ORDER FOR A GEOGRAPHIC REGION

(71) Applicant: Treeswift Inc., Philadelphia, PA (US)

(72) Inventors: Steven Chen, Philadelphia, PA (US); Elizabeth Hunter, Philadelphia, PA (US); Michael Shomin, Philadelphia, PA (US); Elizabeth Martinez, Philadelphia, PA (US); James Paulos, Philadelphia, PA (US)

(21) Appl. No.: 18/444,531

(22) Filed: Feb. 16, 2024

Related U.S. Application Data
(63) Continuation-in-part of application No. 18/391,393, filed on Dec. 20, 2023.
Application No. 18/391,393 is a continuation-in-part of application No. 18/199,863, filed on May 19, 2023.
Application No. 18/199,863 is a continuation-in-part of application No. 18/199,870, filed on May 19, 2023.
(60) Provisional application No. 63/343,979, filed on May 19, 2022.
(60) Provisional application No. 63/446,255, filed on Feb. 16, 2023.
(60) Provisional application No. 63/343,979, filed on May 19, 2022.
(60) Provisional application No. 63/446,255, filed on Feb. 16, 2023.

(51) Int. Cl. G01C 11/04; G06T 7/50; G06T 7/62; G06V 10/40; G06V 20/10; G06V 20/17

(52) U.S. Cl. CPC G01C 11/04; G06T 7/50; G06T 7/62; G06V 10/40; G06V 20/17; G06V 20/176; G06V 20/188; G06T 2207/10032; G06T 2207/30188

(57) ABSTRACT

One variation of a method includes: accessing a scan order, defining a scan type and a target delivery date, for a geographic region; accessing a stored image depicting the geographic region; identifying a stand of trees within the geographic region based visual features detected in the stored image; retrieving a scan profile corresponding to the scan type and including the set of target metric types; constructing a target pathway within the stand of trees traversable by an operator based on the scan profile; accessing a set of environmental forecasts for the geographic region within a time window preceding the target delivery date; calculating a confidence score for completion of the target pathway based on the set of environmental forecasts; and, in response to the confidence score exceeding a threshold confidence score, generating a predicted timeline for a series of events corresponding to the scan order.

### CROSS-REFERENCE TO RELATED APPLICATIONS

This Application is a continuation-in-part application of U.S. patent application Ser. No. 18/391,393, filed on 20 Dec. 2023, which is a continuation-in-part application of U.S. patent application Ser. No. 18/199,863, filed on 19 May 2023, and Ser. No. 18/199,870, filed on 19 May 2023, which claim the benefit of U.S. Provisional Application Nos. 63/343,979, filed on 19 May 2022, and 63/446,255, filed on 16 Feb. 2023, each of which is incorporated in its entirety by this reference.

### TECHNICAL FIELD

This invention relates generally to the field of forestry and more specifically to a new and useful method for tracking and monitoring a scan order for a geographic region in the field of forestry.

### BRIEF DESCRIPTION OF THE FIGURES

FIGS. 1A and 1B are flowchart representations of a method;

FIGS. 2A, 2B, and 2C are flowchart representations of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

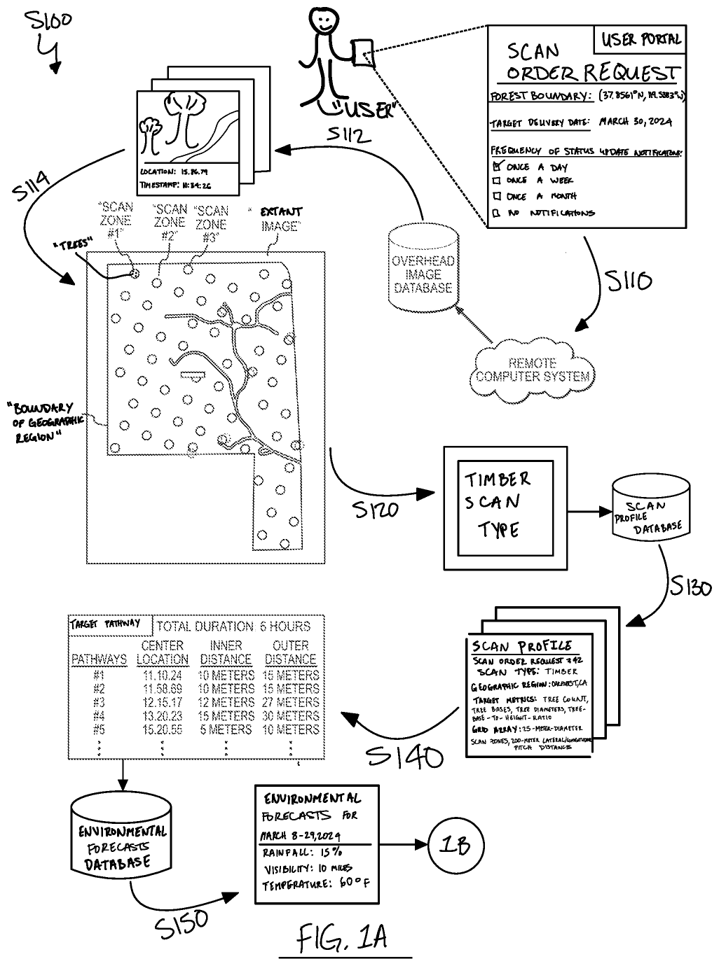

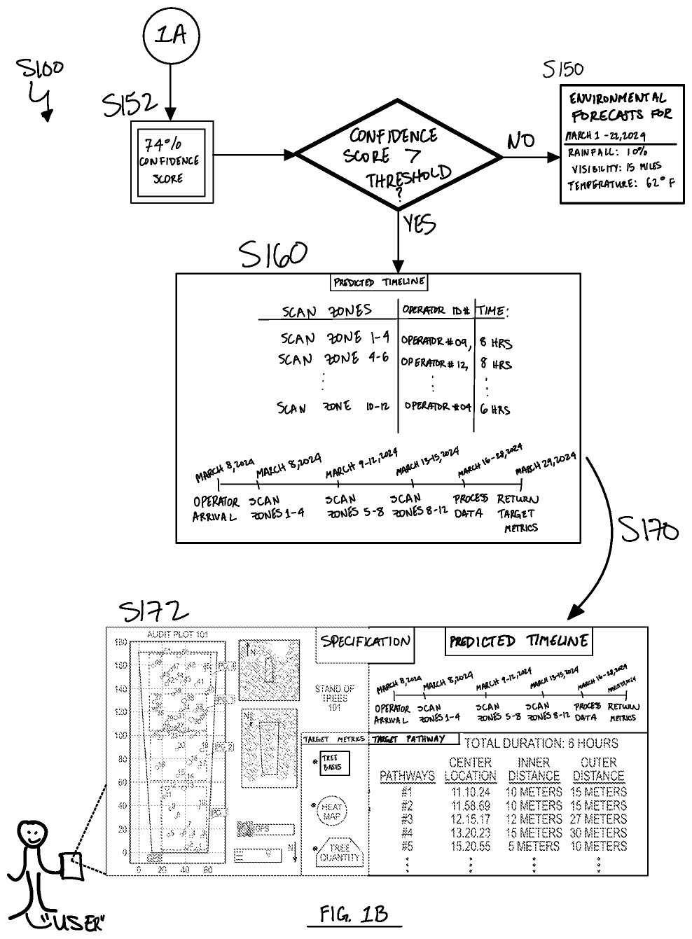

As shown in FIGS. 1A and 1B, a method S100 for tracking a scan order for a geographic region including: accessing the scan order for the geographic region via a user portal, the scan order defining a geospatial boundary for the geographic region and a target delivery date for execution of the scan order in Block S110; accessing a first stored image depicting the geographic region in Block S112; projecting the geospatial boundary onto the first stored image in Block S114; extracts a first set of visual features representing a stand of trees, within the geospatial boundary, from the first stored image; predicting a first scan type, in a set of scan types, for the stand of trees based on historical scan profiles of geographic regions analogous to the geographic region and based on the first set of visual features in Block S120; retrieving a first scan profile, from a set of scan profiles, corresponding to the first scan type and specifying the set of target metric types associated with the first scan type in Block S130; based on the first scan profile, constructing a target pathway, within the stand of trees, traversable by an operator in Block S140; accessing a first set of environmental forecasts for the geographic region for a first time window prior to the target delivery date in Block S150; extracting a second set of visual features representing terrain characteristics along the target pathway, from a region of the first stored image in Block S152; deriving an incline of a ground surface along the target pathway based on the second set of visual features in Block S154; transforming the set of environmental forecasts and the incline of the ground surface into a terrain quality in Block S156; and calculating a first confidence score for completion of the target pathway by the operator, during the first time window, proportional to the terrain quality in Block S158.

The method S100 further includes, in response to the first confidence score exceeding a threshold confidence score: generating a predicted timeline for a series of events corresponding to the scan order in Block S160; aggregating the target metric types, the predicted timeline, and the target pathway into a specification for the scan order in Block S170; and rendering the specification for the scan order within the user portal in Block S172.

### 1.1 Variation: User Confirmation+Operator Credential

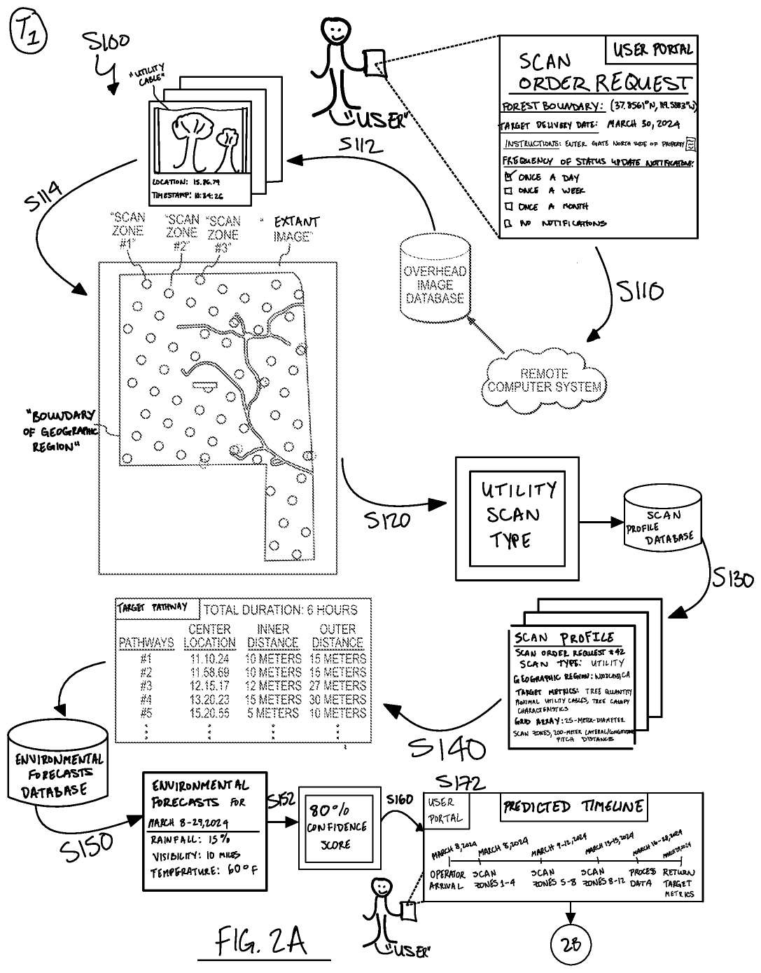

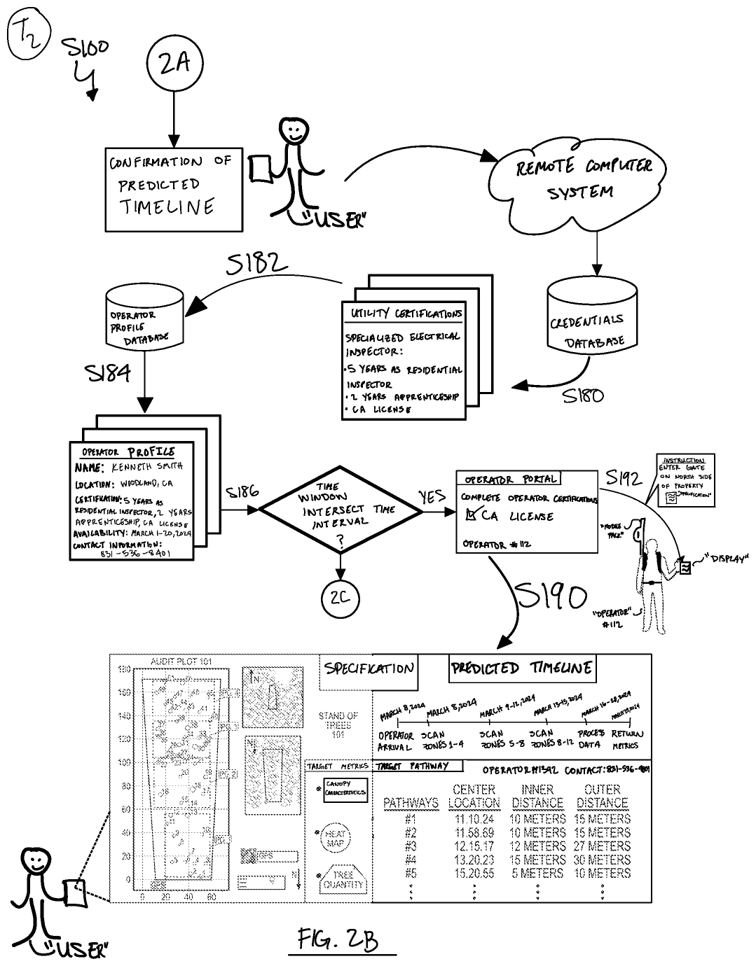

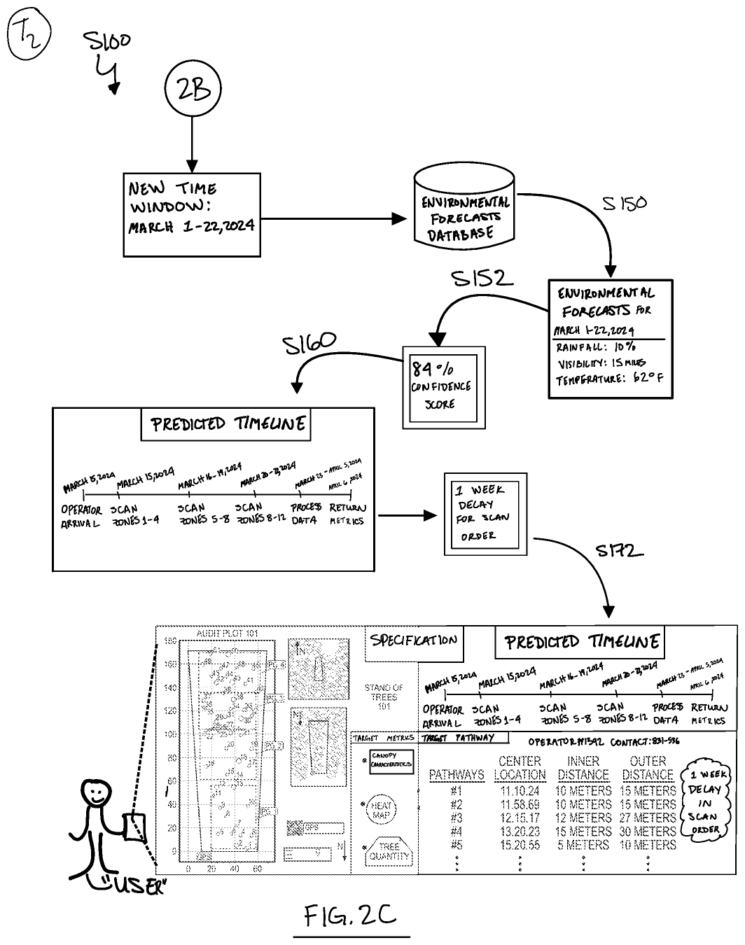

As shown in FIGS. 2A and 2B, one variation of the method S100 includes, during a first time period: accessing the scan order for the geographic region, the scan order defining a target delivery date for execution of the scan order in Block S110; accessing a first stored image depicting the geographic region in Block S112; predicting a scan type for the geographic region based on visual features detected in the first stored image in Block S120; accessing a set of target metric types corresponding to the scan type in Block S130; constructing a target pathway within the geographic region based on the set of target metric types and based on the first stored image in Block S140; accessing a set of environmental forecasts for the geographic region during a time window prior to the target delivery date in Block S150; calculating a confidence score for completion of the target pathway based on the set of environmental forecasts in Block S152; and, in response to the confidence score exceeding a threshold confidence score, generating a predicted timeline for a series of events corresponding the scan order in Block S160 and rendering the predicted timeline within a user portal in Block S172.

This variation of the method S100 further includes, during a second time period in response to receiving confirmation of the predicted timeline: accessing a first credential required for operators completing scans, associated with the sampling type, within the geographic region in Block S180; scanning an operator database for a set of operators located within a threshold distance of the geographic region in Block S182; identifying an operator profile, in a set of operator profiles, affiliated with a first operator, in the set of operators, certified according to the first credential in Block S184; and accessing a set of operator characteristics—including a time interval representing availability of the first operator to complete a scan within the geographic region - to specified by the operator profile in Block S186. This variation of the method S100 further includes, in response to the first time window intersecting the time interval, assigning the first operator to the target pathway for the scan order in Block S190.

### 1.2 Variation: Predicted Timeline

One variation of the method S100 includes: accessing the scan order for the geographic region, the scan order defining a scan type for the geographic region and a target delivery date for execution of the scan order in Block S110; accessing a first stored image depicting the geographic region in Block S112; identifying a stand of trees within the geographic region based on a set of visual features detected in the first stored image in Block S120; retrieving a scan profile, from a set of scan profiles, corresponding to the scan type and specifying the set of target metric types associated with the scan type in Block S130; based on the scan profile, constructing a target pathway, within the stand of trees, traversable by an operator in Block S140; accessing a set of environmental forecasts for the geographic region within a time window preceding the target delivery date in Block S150; calculating a confidence score for completion of the target pathway by the operator based on the set of environmental forecasts in Block S152; and, in response to the confidence score exceeding a threshold confidence score, generating a predicted timeline for a series of events corresponding to the scan order in Block S160.

### 2. Applications

Generally, Blocks of the method S100 can be executed by a remote computer system: to receive a cruise order request (or “scan order request”) for a geographic region (e.g., a forest, a parcel of land) from a user (e.g., a customer, an administrator, a stand manager) affiliated with the geographic region via a user portal; to predict a scan type for the stand of trees within the geographic region; to identify metrics and insights of interest to the user according to the scan type; to construct a target pathway—defining navigation for an operator carrying a mobile pack—intersecting an array of scan zones within the stand of trees or a set of elliptical pathways for each scan zone; to access environmental forecasts for the geographic region (e.g., weather conditions forecast for the geographic region); to leverage these environmental forecasts to generate a predicted timeline for the scan order as a representation of planned execution of the target pathway by the operator and a series of events corresponding to the scan order; to compile the predicted timeline and target pathway into a specification (e.g., a pre-scan report, a visualization) for the scan order; and to present the specification, via the user portal, to the user for feedback.

More specifically, the user may define a geospatial boundary for the particular geographic region, a target delivery date, and select a frequency for status update notifications (e.g., once a day, one a week, once a month) throughout the scan order for the particular geographic region prior to submitting the scan order request. The remote computer system can interface with the user portal to receive the scan order request for the particular geographic region and access an image depicting the particular geographic region from an image database (e.g., an aerial or satellite image database). The remote computer system can then implement computer vision techniques to isolate a stand of trees in the stored image and autonomously predict a scan type for the stand of trees, such as a timber scan type, a carbon sequestration scan type, a utility scan type, or a fire risk scan type.

Additionally or alternatively, the remote computer system can: access a scan profile database; extract an historical scan profile, including an historical geographic region, corresponding to the particular geographic region of the current scan order request from the scan profile database; and, in response to the historical geographic region corresponding to the particular geographic region, identify the scan type, stored in the historical scan profile, as the scan type for the current scan order request. The remote computer system can then retrieve the historical scan profile from the scan profile database and extract target metric types from the historical scan profile including: a total tree count; tree diameters; tree height; tree-height-to-base-ratio; age of trees; foliage density of trees; tree canopy characteristics; tree foliage characteristics; fire risk; pest risk; quantity of dead trees on the floor (e.g., ground) of the geographic region; species; timber volume; total amount of carbon captured by trees; sequestration values; health metrics; etc.

### 2.1 Construction of Target Pathway+Predicted Timeline

Furthermore, the remote computer system can define an operator and equipment (e.g., mobile pack, aerial vehicle, an all-terrain vehicle) to cruise (or “scan”) a scan zone within the geographic region and manually derive the target pathway for an operator carrying a mobile pack to traverse and/or flight paths for an aerial vehicle to navigate for the scan order. Alternatively, the remote computer system can generate a target pathway database over a period of time (e.g., one year, two years, five years) and access target pathways from the database to autonomously derive target pathways and/or flight paths for the scan order.

Upon construction of a target pathway, the remote computer system can: access a set of weather conditions (e.g., an ambient rainfall condition, an ambient temperature of air, a visibility condition) forecast for the geographic region for the time window prior to a target delivery date, defined in the scan order request; calculate a confidence score—such as a value or percentage—representing a likelihood of execution of the target pathway by the operator during the time window based on the set of weather conditions. Responsive to the confidence score exceeding a threshold confidence score, the remote computer system can: generate a predicted timeline for a series of events corresponding to the scan order; aggregate the target metric types, the predicted timeline, and the target pathway into a specification for the scan order; and render the specification for the scan order within the user portal.

In particular, the remote computer system can generate the predicted timeline by: defining dates for the operator, carrying a mobile pack, to arrive and execute the scan for the geographic region; defining dates to collect and process optical and non-optical data from the mobile pack for the scan order; defining a last date to return metrics and insights of interest to the user; estimating a duration for completion of the scan order (e.g., estimated time until delivery, estimated time until completion); and aggregating the operator, equipment, target pathways, dates, and the duration into a predicted timeline for the scan order.

### 2.2 User Feedback+Operator Credential

Additionally, the remote computer system can: prompt a user to define a set of instructions or a set of access points (e.g., a gate, a road, a bridge) specifying entry into and exit from the geographic region for an operator and/or aerial vehicle; write the set of instructions and/or set of access points, for the operator and/or aerial vehicle to the specification; and present the specification to the user via the user portal.

Once the remote computer system serves the specification within the user portal, the user may confirm or reject the predicted timeline, the set of target metric types, or the target pathway within the specification. Responsive to positive user feedback (e.g., confirmation of the predicted timeline), the remote computer system can: access a credential (e.g., a regulation, a certification, a requirement) for operators executing scans within the geographic region; identify an operator—certified according to the credential—to execute the target pathway; assign this operator to the target pathway; and present the target pathway, annotated with instructions specifying entry into and exit from the geographic region, within an operator portal.

Alternatively, responsive to absence of an operator exhibiting a set of credentials associated with the geographic region and the particular scan type, the remote computer system can: access an operator database and scan operator profiles affiliated with operators occupying locations proximal (e.g., within a threshold distance of) the geographic region; select an operator nearest the geographic region; and present the set of credentials to this operator within the operator portal. Responsive to completion of the set of credentials by the operator, the remote computer system can: assign the operator to the target pathway for the scan order; and present the specification within the user portal.

### 2.3 Post-Scan: Status Updates+Three-Dimensional Representation

Once the user (e.g., customer, administrator, stand manager) confirms the specification and availability of the set of access points, the remote computer system can initiate the specification to dispatch an operator and/or the aerial vehicle to a stand of trees within the particular geographic region. During a scan of trees in a first scan zone in the particular geographic region, the remote computer system can: receive optical data (e.g., low-resolution images) and non-optical data (e.g., ambient data, geospatial data, deviations) from the local controller in the mobile pack carried by the operator and/or from the wireless communications module in the aerial vehicle; and characterize a quality of these data. Then, in response to the quality of these data exceeding a quality threshold, the remote computer system can: generate a status update notification showing the specification as “on-time”; and present this status update notification to the user via the user portal.

Additionally, upon completion of a scan for the particular geographic region (e.g., post-scan), the remote computer system can: derive a three-dimensional representation of the geographic region; extract metrics and insights—designated by the user in the scan order request or stored in a scan profile—from this three-dimensional representation such as locations, sizes, and characteristics of trees (e.g., height, carbon volume, health, fire risk, pest risk) within the geographic region; and present these metrics and insights to the user within the user portal and thereby, enable the user to timely review designated metrics upon completion of the predicted timeline for the scan order (e.g., post-scan) and to develop informed decisions (e.g., harvest times, pest mitigation strategies, fire risk mitigation) regarding a stand of trees within the particular geographic region.

### 3. Aerial Vehicle

In one implementation, the aerial vehicle defines an autonomous airborne robotic system including: a chassis; a flight controller; a geolocation module; a wireless communications module; and a sensor suite including optical sensors (e.g., an RGB camera, a hyper-spectral camera, a LIDAR sensor), proximity sensors, and/or ambient condition sensors (e.g., temperature sensor, humidity/moisture sensor, light intensity sensor). The aerial vehicle is configured to: autonomously navigate to above, below, and around a stand of trees; record optical (e.g., RGB, depth, multispectral) images of trees and other objects within the stand of trees; write a georeferenced location and altitude of the aerial vehicle to each optical image (e.g., via the geolocation module); track and maintain minimum distances from other objects (e.g., via the LIDAR sensor); record ambient conditions (e.g., via ambient sensors); and transmit image and geospatial location data to the remote computer system via the communications module.

In one implementation, the aerial vehicle includes: a suite of upward-facing optical sensors (e.g., RGB color and LIDAR depth sensors) mounted above the aerial vehicle chassis and oriented with fields of view directed upwardly from the chassis; and a suite of downward-facing optical sensors mounted below the aerial vehicle chassis and oriented with fields of view directed downwardly from the aerial vehicle chassis.

In another implementation, the aerial vehicle includes a suite of proximity sensors oriented about the aerial vehicle chassis and configured to detect proximity of objects—such as tree limbs or biowaste on a forest floor—above, below, and adjacent the aerial vehicle. For example, the aerial vehicle can include ultrasonic, electromagnetic, RADAR, and/or SONAR sensors fixedly- or dynamically-mounted to the aerial vehicle chassis.

### 4. Mobile Pack

The mobile pack (e.g., a backpack, a bag, a knapsack) includes: a set of (e.g., two) straps configured to contact shoulders of an operator; a chassis; a boom (e.g., a mast) extending from the chassis and above a head of an operator carrying the mobile pack; a geolocation module (e.g., a global positioning system) coupled to the boom; a sensor suite including optical sensors (e.g., an RGB camera, a hyper-spectral camera, a LIDAR sensor, an omnidirectional camera), proximity sensors, and/or ambient condition sensors (e.g., temperature sensor, humidity/moisture sensor, light intensity sensor) coupled to the boom; an integral display (e.g., output device) removably coupled to the chassis; a housing coupled to the chassis; a wireless communications module (i.e., local controller) arranged in the housing; and a battery module arranged in the housing, as shown in

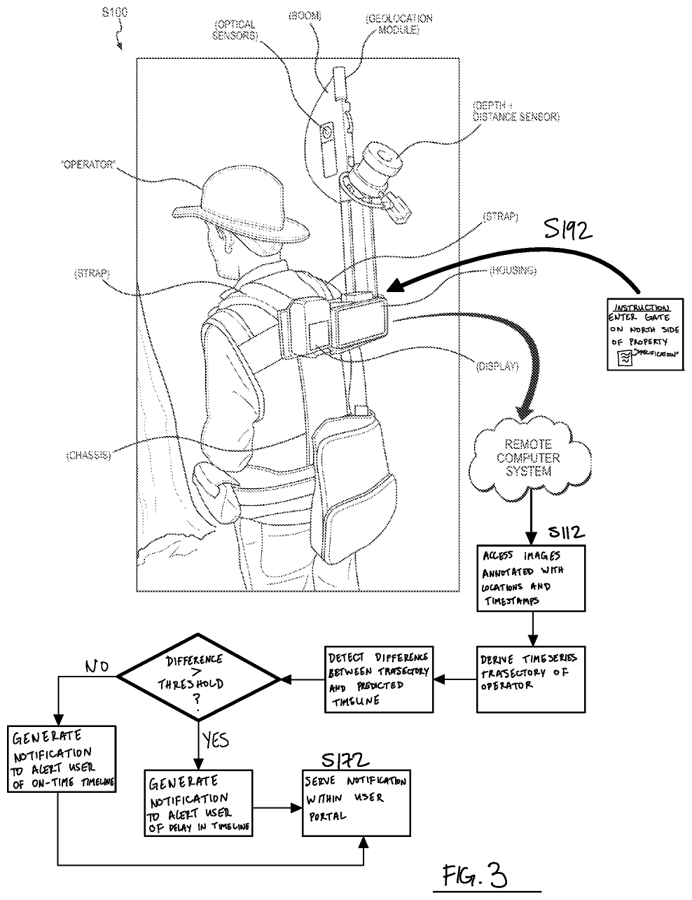

FIG. 3.

In one implementation, the boom extends from the chassis and above a head of an operator carrying the mobile pack, defines a front face proximal a head of the user, and defines a rear face opposite the front face. In this variation, the set of optical sensors and the geolocation module (e.g., a global positioning system) are coupled to the front face of the boom and a depth sensor (e.g., a LIDAR depth sensor) is coupled to the rear face of the boom. The display is coupled to an upper edge of the chassis orthogonal to the boom and facing away from the set of straps. The housing is coupled to the upper edge of the chassis proximal the display and houses the local controller and the battery module. The housing is further configured to protect and reduce damage to the local controller and the battery module from external objects (e.g., tree limbs, leaves, rocks) within the forest and adverse weather conditions (e.g., heat, rain, snow, fog). The mobile pack further exhibits a weight within a target weight range and thereby enables an operator to traverse a target pathway through scan zones within the stand of trees according to the cruise plan, while carrying the mobile pack and additional personal items.

In one variation, the geolocation module, the local controller, the integral display, and the suite of sensors can be arranged within the housing of the mobile pack and the sensor suite and other sensors can be configured to install on the chassis of the mobile pack—such as by adhering or mechanically fastening to the chassis—with the field of view of each sensor facing outwardly from the chassis and intersecting a scan zone within the stand of trees.

In another variation, the mobile pack further includes: a chassis defining a longitudinal axis—parallel to a vertical axis of a user carrying the mobile pack—and configured to receive and retain optical sensors—in six degrees of freedom—while the operator traverses each scan zone; a suite of upward-facing optical sensors (e.g., RGB color and LIDAR depth sensors)—each optical sensor defining a field of view directed toward the tree-line of the stand of trees—mounted to a first side of the chassis along the longitudinal axis; and a suite of downward-facing optical sensors—each optical sensor defining a field of view directed toward the ground of the stand of trees—mounted to a second side of the chassis along the longitudinal axis.

In yet another variation, the housing of the mobile pack includes a suite of proximity sensors located along the first side and the second side of the longitudinal axis of the chassis and configured to detect proximity of objects—such as tree limbs or biowaste on a forest floor—to the mobile pack. For example, the mobile pack can include ultrasonic, electromagnetic, RADAR, and/or SONAR sensors fixedly mounted or dynamically mounted to the chassis.

In yet another variation, the housing of the mobile pack includes a display (e.g., output device) integrated into the mobile pack and electrically coupled to the battery of the mobile pack, such as via a wired connection running from the battery to the display, to enable an operator to remove the display from the chassis of the mobile pack and hold the display to review the cruise plan or a target pathway while the operator traverses each scan zone. The display is further configured to wirelessly connect to a computing device (e.g., a smart phone, a mobile device, a tablet) accessible by an operator while the operator traverses the array of scan zones. In this variation, the mobile pack also includes an accelerometer configured to calculate the velocity (i.e., speed) of the operator carrying the mobile pack during the cruise plan.

Therefore, the mobile pack enables an operator to traverse the array of scan zones within a stand of trees according to a cruise plan—while carrying the mobile pack—to collect data of the forest and offload these data, via the local controller, to a remote computer system to further extract metrics and insights of the forest. However, this “standalone,” “mobile” pack can define any other form and is configured for an operator to carry the mobile pack in any other way.

### 4.1 Sensor Suite: Optical Sensors and Other Sensors

The suite of sensors can include: optical sensors (e.g., color cameras, omnidirectional cameras) configured to record and output two-dimensional color images; depth sensors (e.g., depth cameras) configured to record and output two-dimensional depth images or three-dimensional point clouds; a distance sensor (e.g., a one-dimensional infrared depth sensor, a two-dimensional LIDAR sensor) defining a field of view of a tree line within a stand of trees; an audio sensor (e.g., a transducer, a microphone); an ambient light sensor; a temperature sensor; an air quality or air pollution sensor; and/or a humidity sensor. However, the suite of sensors can include any other type of optical sensor, output visual, optical, or non-optical data in any other format, and include any other ambient sensor.

### 4.2 Local Controller

The local controller is configured to: record optical (e.g., RGB, depth, multispectral) images of trees and other objects (e.g., leaves, shrubbery, rocks, hills, drop- offs) within a stand of trees; locate a marker inserted into a target plot within the stand of trees by an operator associated with the mobile pack (e.g., carrying the mobile pack); write a cotemporal location of the mobile pack and marker to each optical image (e.g., via the geolocation module); track and maintain minimum distances from other objects (e.g., via the LIDAR sensor); record ambient conditions (e.g., via ambient sensors); and generate a two-dimensional (or “two-dimensional”) map of the stand of trees.

Furthermore, the local controller is configured to transmit optical and geospatial location data to the remote computer system to generate a three-dimensional (or “three-dimensional”) model of the stand of trees. Accordingly, the remote computer system can leverage this three-dimensional model of the stand of trees to extract metrics and insights and execute actions (e.g., generate notifications, generate prompts) as further described below.

### 5. Remote Computer System

The remote computer system—such as a remote server—can receive a scan order request for a geographic region (e.g., geographic region) from a user (e.g., customer, administrator, manager) affiliated with the geographic region via a user portal and generate a specification—defining an target pathway for an operator carrying the mobile pack to traverse and/or an order of flight paths for an aerial vehicle to navigate -corresponding to this scan order request. Additionally, the remote computer system can monitor the scan order and execute actions (e.g., generate prompts, generate status update notifications, generate reports) throughout the scan order (e.g., pre-cruise, in-process cruise, post-scan). The remote computer system can further present real-time timeline notifications to the user within the user portal.

Furthermore, the remote computer system can receive optical data (e.g., low-resolution images) and non-optical data (e.g., ambient data, proximity data, geospatial location data) from the local controller arranged within the mobile pack and/or from the wireless communications module within the aerial vehicle during a cruise of a target plot (e.g., in-process cruise). The remote computer system can manipulate these optical and non-optical data: to update the time interval (e.g., estimated time until delivery, estimated time until completion) for the scan order request placed by the user (e.g., customer, administrator, manager); to generate status update notifications; to extract metrics and insights of the geographic region; and/or to present these status update notifications, metrics, and insights to the user based on these data.

Alternatively, after the cruise for each target plot is complete (e.g., post-scan) the remote computer system can: receive optical data (e.g., hi-resolution images) and non-optical data (e.g., ambient data, proximity data, geospatial location data); derive a three-dimensional representation of the geographic region and extract metrics such as locations, sizes, and characteristics (e.g., height, carbon volume, health, pest pressure) of trees within the geographic region; and present these metrics to the user (e.g., customer, administrator, manager affiliated with the scan order request for the geographic region) for review.

### 5.1 User Portal

The remote computer system can further interface with a user portal to assist users with scan order requests, installation, rework, and status updates of scan orders. The remote computer system can display various interfaces within the user portal to a user via a user's computing device (e.g., a smartphone, a tablet, a laptop computer) including: input interfaces for specifying a scan order request for a geographic region and parameters for generation of a plan for the stand of trees or otherwise configuring the scan order; and prompt interfaces that prompt the user to select particular metrics and/or insights for the geographic region defined in the cruise order request.

### 6. Setup Period

Generally, during a setup period (e.g., pre-scan period), the remote computer system can receive a scan order request for a particular geographic region (e.g., forest, stand of trees within a forest) from a user (e.g., customer, administrator, manager affiliated with the particular geographic region) via a user portal. The remote computer system can interface with the user portal to receive the scan order request for the particular geographic region and access an image depicting the particular geographic region from an image database (e.g., an aerial or satellite image database). The remote computer system can then implement computer vision techniques to isolate a stand of trees in the stored image and autonomously predict a scan type for the stand of trees in the stored image. The remote computer system can further retrieve a scan profile, from a scan profile database, corresponding to the scan type and including the set of target metric types in order to construct a target pathway, for execution by an operator, within the stand of trees. The remote computer system can then generate a predicted timeline for the scan order and compile the target metric types, the predicted timeline, the target pathway, and the image into a specification for the scan order.

More specifically, the remote computer system can: define an operator and equipment (e.g., mobile pack, aerial vehicle) to scan the target plot; and construct a target pathway defining navigation of the operator for a target plot. The remote computer system can also access a set of environmental forecasts from a weather database for a time window prior to the target delivery date and calculate a confidence score representing a likelihood of execution of the target pathway by the operator within the time window based on the set of environmental forecasts. Responsive to the confidence score exceeding a threshold confidence score, the remote computer system can generate a predicted timeline for a series of events corresponding to the scan order.

In particular, the remote computer system can generate a predicted timeline for a series of events corresponding to the scan order by: defining dates for the operator to arrive to commence and execute the target pathway; defining dates to collect optical and non-optical data from the scan and return metrics and insights corresponding to the scan order to the user; and compiling these dates into a predicted timeline (e.g., estimated time until delivery, estimated time until completion) for execution of the scan order. The remote computer system can then aggregate the operator, equipment, target pathway, and the predicted timeline into a specification for the scan order and present the specification for confirmation within the user portal.

Furthermore, during the setup period, the remote computer system can: access a set of images depicting the particular geographic region; generate a set of waypoints defining navigation of an operator carrying the mobile pack through the particular geographic region (i.e., a target pathway); and estimate a predicted timeline (e.g., a duration) for the operator to traverse along the target pathway through the particular geographic region and collect optical and non-optical data of the particular geographic region. Additionally or alternatively, the remote computer system can: generate a set of waypoints defining navigation of an aerial vehicle through the particular geographic region (i.e., a flight path); and estimate a predicted timeline (e.g., duration) for the aerial vehicle to execute the flight path and collect optical and non-optical data of the particular geographic region.

Additionally, the remote computer system can assign a set of access points for the operator and/or aerial vehicle to enter into and exit from the stand of trees to the specification and present the specification to the user via the user portal during the setup period (e.g., pre-scan period).

### 6.1 Scan Order Request+Manual Selection

In one implementation, during the setup period, the remote computer system can receive a scan order request for a particular geographic region from a user via the user portal. In this implementation, the user may define boundaries of the particular geographic region, define a target delivery date, select a scan type and target metric types for the scan order, and select a frequency for status update notifications associated with the scan order request throughout each scan of the set of target plots prior to submitting the scan order request.

In one variation, during the setup period, the user may define a set of geospatial vertices of a target stand of trees within the particular geographic region for the scan order such as (x,y) coordinates corresponding to a latitude and longitude within a map of the particular geographic region. The user may then define a target delivery date, such as Mar. 30, 2024 and select a scan type from a menu of predefined scan types (e.g., a list, a table, or a catalog of scan types). Accordingly, the remote computer system can present a menu of predefined target metric types (e.g., a list, a table, or catalog of target metric types), associated with the selected scan type, within the user portal for the scan order of the particular geographic region. The user may select a set of target metric types from the menu of predefined target metric types and select a frequency for status update notifications (e.g., once a day, once a week, once a month) associated with the scan order request throughout each scan of trees in the particular geographic region). The remote computer system can then interface with the user portal to receive the scan order request.

Furthermore, the remote computer system can display a menu of predefined scan types associated with the particular geographic region of the scan order request. In particular, the remote computer system can display a menu of predefined scan types including: a timber scan type; a carbon sequestration scan type; a utility scan type; a fire risk scan type; etc. The user may then select a scan type of interest to the user for the particular geographic region. Once the user selects a scan type, the remote computer system can display a menu of predefined target metric types, associated with the selected scan type, including: a total tree count; tree diameters; tree height; age of trees; foliage density of trees; tree canopy characteristics; fire risk; pest risk; quantity of dead trees on the floor (e.g., ground) of the geographic region; species; timber volume; total amount of carbon captured by trees; sequestration values; health metrics; etc. The user may select a set of target metric types of interest to the user for the particular geographic region. The user may also select a frequency for status update notifications (e.g., once a day, once a week, once a month) associated with the scan order request throughout each scan of the set of target plots.

For example, a user (e.g., customer) affiliated with a particular geographic region can interface with the user portal to generate a scan order request of a particular geographic region and define a set of (e.g., four) geospatial vertices of a stand of trees (e.g., polygon-shaped region) within this particular geographic region. In this example, the customer defines: a first geospatial vertex of (37.588119, −119.686412), a second geospatial vertex of (37.596824, −119.564165), a third geospatial vertex of (37.498831, −119.568308), and a fourth geospatial vertex of (37.504279, −119.760604). The remote computer system displays a menu of predefined scan types within the user portal and the user selects a timber scan type from the menu. The remote computer system then displays a menu of predefined target metric types, associated with the timber scan type, within the user portal. The user selects a set of target metric types for the scan order from the menu, such as a first target metric type representing base diameters of trees, a second target metric type representing heights of trees, and a third target metric type representing a tree-base-to-height ratio of trees in this particular geographic region. The user further selects a frequency to receive status update notifications, such as once a week, throughout execution of the scan order and submits this scan order request via the user portal.

Thus, a user may interface with the user portal to submit a scan order request for a particular geographic region and define boundaries for scanning a stand of trees within this geographic region. The user may further select a scan type and target metric types associated with the scan type for the particular geographic region and a frequency for status update notifications prior to submitting the scan order request.

### 6.2 Scan Order Request+Automatic Selection

In one implementation, during the setup period, the remote computer system can receive a scan order request for a particular geographic region from a user via the user portal. The user may define a geospatial boundary for the particular geographic region, a target delivery date, and select a frequency for status update notifications throughout the scan order for the particular geographic region prior to submitting the scan order request. Accordingly, the remote computer system can interface with the user portal to receive the scan order request for the particular geographic region and access an image depicting the particular geographic region from an image database (e.g., an aerial or satellite image database). The remote computer system can then implement computer vision techniques to isolate a stand of trees in the stored image and autonomously predict a scan type for the stand of trees.

In one variation, the remote computer system can interface with the user portal to receive the scan order request for the particular geographic region and access an image database. The remote computer system can: retrieve a stored image depicting the geographic region from the image database; project the geospatial boundary onto the stored image; extract a set of visual features from the stored image; and, based on the set of visual features, isolate a stand of trees within the geospatial boundary in the stored image and predict a scan type for the stand of trees in the stored image.

Furthermore, the remote computer system can: track scan order requests over a period of time (e.g., one month, six months, one year); link a scan type, a set of target metric types, an array of scan zones, and a geographic region associated with each scan order request in a scan profile; and store these scan profiles in a scan profile database. The remote computer system can then retrieve historical scan profiles from the scan profile database to predict a scan type for the stand of trees in the stored image.

### 6.2.1 Scan Profile Database+Target Pathway Construction

Generally, the remote computer system can: track scan order requests over a period of time (e.g., one month, six months, one year); link a scan type, a geographic region, and a set of target metric types associated with each scan order request in a scan profile; and store these scan profiles in a scan profile database. The remote computer system can then receive a current scan order request and retrieve historical scan profiles from the scan profile database to predict a scan type for the particular geographic region defined in the current scan order request.

More specifically, the remote computer system: interfaces with the user portal to receive a current scan order request for a particular geographic region; accesses the scan profile database; extracts an historical scan profile, including an historical geographic region, corresponding to the particular geographic region of the current scan order request from the scan profile database; and, in response to the historical geographic region corresponding to the particular geographic region, identifies the scan type, stored in the historical scan profile, as the scan type for the current scan order request.

Furthermore, the remote computer system can store an array of scan zones unique to each scan type within each scan profile in the scan profile database. The remote computer system can retrieve an array of scan zones from an historical scan profile and project the array of scan zones onto the stored image in order to construct a target pathway intersecting the array of scan zones for execution by an operator carrying the mobile pack.

In one variation, the remote computer system can: access an image database including overhead images captured by an aerial vehicle; select an overhead image, depicting the geographic region from the image database; and extract a first set of visual features from a first region of the overhead image representing tree characteristics of a first set of trees. Upon prediction of a scan type, the remote computer system can retrieve a scan profile—defining an array of scan zones associated with the scan type and a set of target metric types for the array of scan zones—corresponding to the scan type from the scan profile database; and project a first scan zone, in the array of scan zones, onto the first region of the overhead image to encompass the first set of trees. The remote computer system can then: extract a second set of visual features from a second region of the overhead image representing tree characteristics of a second set of trees; and project a second scan zone, in the array of scan zones, onto the second region of the overhead image to encompass the second set of trees.

The remote computer system can repeat the methods and techniques described above for each other region of the overhead image and for each other set of trees to project the array of scan zones onto the overhead image within the stand of trees. Accordingly, the remote computer system can construct the target pathway intersecting the array of scan zones within the stand of trees traversable by an operator carrying a mobile pack, as further described below.

In one example, the remote computer system: interfaces with the user portal to receive a current scan order request for a particular geographic region; accesses the scan profile database; extracts an historical scan profile, including an historical geographic region, corresponding to the particular geographic region of the current scan order request from the scan profile database; and, in response to the historical geographic region corresponding to the particular geographic region, identifies a timber scan type, stored in the historical scan profile, as the scan type for the current scan order request. The remote computer system then retrieves the historical scan profile from the scan profile database corresponding to the timber scan type and extracts: a first target metric type representing base diameters of the stand of trees; a second target metric type representing heights of the stand of trees; and a third target metric type representing a tree-base-to-height ratio of the stand of trees from the historical scan profile.

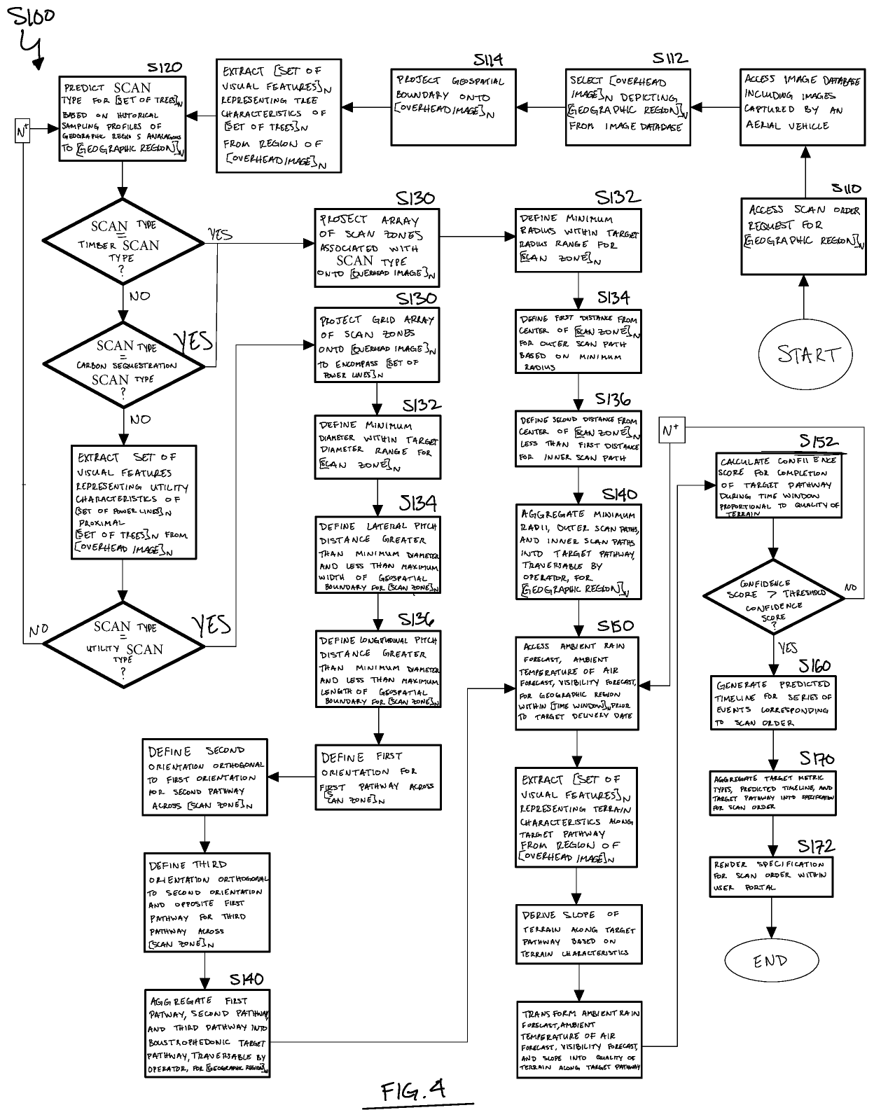

The remote computer system projects the array of scan zones onto the region of the stored image and for each scan zone in the array of scan zones: define a minimum radius within a target radius range for the scan zone; define a first distance from a center of the scan zone for an outer scan path based on the minimum radius; and define a second distance from the center of the scan zone, less than the first distance, for an inner scan path. The remote computer system then: aggregates minimum radii, outer scan paths, and inner scan paths into a target pathway intersecting the array of scan zones, traversable by the operator carrying a mobile pack, for the geographic region; and aggregates the first target metric type, the second target metric type, the third target metric type, the predicted timeline, and the target pathway into the specification for the scan order, as shown in FIG. 4.

Additionally or alternatively, in response to the historical geographic region corresponding to the particular geographic region, the remote computer system: identifies a carbon sequestration scan type, stored in the historical scan profile, as the scan type for the current scan order request. The remote computer system then retrieves the historical scan profile from the scan profile database corresponding to the carbon sequestration scan type and extracts: a first target metric type representing a total quantity of trees in the stand of trees; a second target metric type representing base diameters of the stand of trees; and a third target metric type representing a volume of carbon captured by the stand of trees from the historical scan profile. The remote computer system then aggregates the first target metric type, the second target metric type, the third target metric type, the predicted timeline, and the target pathway into the specification for the scan order, as further described below.

### 6.2.2 Grid Array of Scan Zones

In one variation, the remote computer system can: access an overhead image depicting the stand of trees; extract visual features from regions of the overhead image; characterize a difference between visual features of a first region and a second region of the overhead image; and project an array of scan zones onto the overhead image—within the boundary of the stand of trees—based on the difference.

Furthermore, the remote computer system can virtually project a two-dimensional grid array of 25-meter-diameter scan zones at 200-meter lateral and longitudinal pitch distances onto the overhead image. In this variation, the remote computer system can project a two-dimensional grid array of scan zones onto the overhead image, each scan zone: defining a minimum diameter within a target diameter range (e.g., between 20-meter-diameter and 30-meter-diameter, between 23-meter-diameter and 27-meter-diameter); defining a lateral pitch distance greater than the minimum diameter and less than a maximum width of the boundary of the stand of trees (e.g., 200 meter lateral pitch distance); and defining a longitudinal pitch distance greater than the minimum diameter and less than a maximum length of the boundary of the stand of trees (e.g., 200 meter longitudinal pitch distance).

For example, the remote computer system can: access an overhead image depicting the stand of trees; extract a first set of visual features from a first region—representing tree characteristics of a first set of trees—of the overhead image; extract a second set of visual features from a second region—representing tree characteristics of a second set of trees—of the overhead image; and characterize a difference between the first set of visual features and the second set of visual features. Then, in response to the difference between the first set of visual features and the second set of visual features exceeding a difference threshold (e.g., 70%), the remote computer system can: project a first scan zone (e.g., defining a 25-meter-diameter) onto the first region of the overhead image to encompass the first set of trees; and project a second scan zone (e.g., defining a 25-meter-diameter, a 200 meter lateral pitch distance, and a 200 meter longitudinal pitch distance from the first scan zone), onto the second region of the overhead image to encompass the second set of trees.

The remote computer system can repeat these methods and techniques for each other set of trees and for each other scan zone to virtually project the array of scan zones onto the overhead image. However, the remote computer system can project the array of scan zones onto the overhead image in any other way.

### 6.2.3 Example: Utility Scan Type Prediction

In one example, a stand management team may plan to harvest trees in a parcel of land including a stand of trees within a threshold distance of a set of aerial utility cables (e.g., power lines). The stand management team may submit a scan request for the parcel of land and the remote computer system can automatically predict a utility scan type and a set of target metric types for the scan order.

In one variation, the remote computer system interfaces with the user portal to receive a scan order request for a particular geographic region, such as a parcel of land covered by a stand of trees in California, submitted by a stand management user. The remote computer system then: retrieves the geospatial boundary, defined in the scan order request, including a set of (e.g., four) geospatial vertices for the stand of trees, such as a first geospatial vertex of (37.588119, −119.686412), a second geospatial vertex of (37.596824, −119.564165), a third geospatial vertex of (37.498831, −119.568308), and a fourth geospatial vertex of (37.504279, −119.760604); retrieves a stored image depicting the parcel of land from the image database according to the set of geospatial vertices;

projects the set of geospatial vertices onto the stored image; extracts a first set of visual features, representing utility characteristics of a first set of power lines proximal (e.g., within a threshold distance of) the stand of trees, from the first stored image;; and predicts a utility scan type based on the first set of visual features and based on historical scan profiles of geographic regions analogous to the geographic region.

Accordingly, the remote computer system accesses the scan profile database and selects an historical scan profile associated with an historical geographic region corresponding to the parcel of land and confirms the utility scan type prediction. The remote computer system then retrieves an array of scan zones associated with the utility scan type and a set of target metric types from this historical scan profile including: a first target metric type representing a quantity of trees within a threshold distance (e.g., two feet) of the set of power lines; a second target metric type representing a set of canopy characteristics of the quantity of trees within the threshold distance (e.g., two feet) of the set of power lines; and a third target metric type representing a fire risk of trees within the threshold distance of the first set of power lines.

Furthermore, the remote computer system projects the array of scan zones onto the region of the extant image. Then, for each scan zone in the array of scan zones, the remote computer system: defines a first orientation for a first pathway across the scan zone; defines a second orientation orthogonal to the first orientation for a second pathway across the scan zone; and defines a third orientation orthogonal to the second orientation and opposite the first pathway for a third pathway across the scan zone. The remote computer system then aggregates these pathways into a boustrophedonic target pathway, traversable by the operator, for the geographic region, as shown in FIG. 4.

### 6.3 Manual Target Pathway and Flight Paths

Furthermore, the remote computer system can generate a set of target pathways for an operator carrying a mobile pack to traverse and/or a set of flight paths for an aerial vehicle to execute within the stand of trees for the specification.

In one implementation, in response to receiving a scan order request for a particular geographic region, the remote computer system can: access a set of aerial or satellite images depicting the particular geographic region based on the set of geospatial vertices defined by the user in the request; extract a set of features from each image in the set of images representing the terrain of the particular geographic region (e.g., trees, rocks, shrubbery, drop-offs, inclines, bridges, roads, leaves); detect a stand of trees within a first image in the set of images based on the set of features; and define a set of target plots within the stand of trees for an operator carrying the mobile pack to traverse and/or a set of target plots for an aerial vehicle to scan for the scan order request. Then, for each target plot in the set of target plots, the remote computer system can: retrieve a first quantity of steps that an operator carrying a mobile pack can traverse; assign the operator carrying the mobile pack to the target plot based on the first quantity of steps; and construct a target pathway defining navigation of the operator carrying the mobile pack for the target plot.

In one variation, during the setup period, the remote computer system can access data representing the forest and generate a set of waypoints defining navigation for the operator carrying the mobile pack through the forest. In this variation, the remote computer system can: access a set of overhead images, such as aerial or satellite images from an aerial mapping service, depicting a particular stand of trees within the forest as defined in the scan order request; scan these overhead images representing the stand of trees and the surrounding topographical features, to define a set of scan zones and detect obstacles near and within each scan zone, such as shrubs, rocks, drop-offs, and/or tree stumps; and define a pathway and/or flight path intersecting the array of scan zones, such as nominally offset from trees by a predefined target offset distance (e.g., six feet), and that maintains a minimum distance (e.g., two feet) from detected obstacles. The remote computer system can then construct an ordered sequence of geospatially-referenced keypoints along the pathway and/or flight path, such as offset by the target offset distance (e.g., six feet).

The remote computer system can repeat the methods and techniques described above for each other scan zone within the stand of trees to compile keypoints into a target pathway and/or target flight path for the scan order. The remote computer system can receive confirmation of the target pathway and/or target flight path from the user and transmit the target pathway to the local controller of the mobile pack or the target flight path to the communication module in the aerial vehicle.

The remote computer system can repeat the methods and techniques described above for each other scan within the stand of trees to compile keypoints for each target pathway and/or flight path; and transmit each target pathway to the local controller in the mobile pack carried by an operator and/or each flight path to the wireless communications module in the aerial vehicle. The remote computer system can also: assign an identifier (e.g., numerical number, UUID) to each target pathway and/or flight path; define a sequential order of target pathways and/or flight paths for the stand of trees; and transmit the sequential order with the corresponding target pathways to the local controller arranged within the mobile pack and/or flight paths to the wireless communications module arranged within the aerial vehicle.

For example, the remote computer system can: retrieve a quantity of steps (e.g., 10,000) that an operator carrying a mobile pack can traverse within the stand of trees; assign one operator carrying a mobile pack to the scan order based on the quantity of steps that the operator can traverse; access an overhead image depicting the stand of trees; access the geospatial boundary of the stand of trees; project the geospatial boundary onto the overhead image; and project the array of scan zones onto the overhead image.

Then, for each scan zone in the array of scan zones, the remote computer system can: define a minimum radius within a target radius range for the scan zone; define a first distance from a center of the scan zone for an outer scan path based on the minimum radius; and define a second distance from the center of the scan zone, less than the first distance, for an inner scan path. The remote computer system can aggregate minimum radii, outer scan paths, and inner scan paths into a set of elliptical pathways through the array of scan zones for execution by the user carrying the mobile pack; and transform the set of elliptical pathways into a target pathway defining navigation of the operator carrying the mobile pack for the scan order.

Alternatively, for each target plot in the set of target plots, the remote computer system can: calculate an area (e.g., 5 miles) that an aerial vehicle can scan prior to depletion of the battery; assign an aerial vehicle to complete the scan according to the area that the aerial vehicle can scan prior to depletion of the battery; and construct a flight path defining navigation of the aerial vehicle for the target plot. The remote computer system can then: assign an identifier (e.g., numerical number) to each target pathway and/or flight path; define a sequential order of target pathways and/or flight paths for the stand of trees; and transmit the sequential order with the corresponding target pathways to the local controller arranged within the mobile pack and/or flight paths to the wireless communications module arranged within the aerial vehicle.

Thus, the remote computer system can access predefined or known metrics associated with operators carrying the mobile pack and/or associated with aerial vehicles to manually derive target pathways and/or flight paths corresponding to the scan order request.

### 6.3.1 Autonomous Target Pathways and Flight Paths

Additionally or alternatively, the remote computer system can access a scan path database to autonomously derive a target pathway and/or flight path for execution by an operator carrying the mobile pack or an aerial vehicle to scan trees within the geographic region.

In one variation, the remote computer system can collect non-optical data (e.g., quantity of steps, area covered, equipment, target pathways, flight paths) from each scan of a stand of trees over a period of time (e.g., one year, two years, five years). Then, the remote computer system can store these non-optical data for each scan in a scan path database. The remote computer system can then: receive a scan order request from a user via the user portal; access the scan path database; and autonomously generate a target pathway and/or flight path for the corresponding scan order request based on analogous non-optical data stored in the scan path database.

For example, the remote computer system can: access a scan path database; extract a quantity of steps (e.g., 5,000) that an operator carrying a mobile pack can traverse from the scan order database; assign a set of (e.g., 4) operators carrying a mobile pack based on the quantity of steps; extract an area (e.g., 5 miles) that an aerial vehicle can scan prior to depletion of the battery from the scan order database; assign a set of (e.g., 2) aerial vehicles to complete the scan according to the area; generate a first set of waypoints defining navigation of each operator carrying the mobile pack through the geographic region (i.e., a target pathway); and generate a second set of waypoints defining navigation of each aerial vehicle through the geographic region (i.e., a flight path). The remote computer system can then: assign an identifier (e.g., numerical number) to each target pathway and/or flight path; define a sequential order of target pathways and/or flight paths for the stand of trees; and transmit the sequential order with the corresponding target pathways to the local controller arranged within the mobile pack and/or flight paths to the wireless communications module arranged within the aerial vehicle.

Therefore, the remote computer system can generate a scan path database over a period of time and leverage the scan path database to autonomously derive target pathways and/or flight paths to complete a scan of the stand of trees for the scan order request.

### 6.4 Specification

Once the remote computer system receives a scan order request—including a geospatial boundary, a target delivery date, and a frequency for status update notifications—of the stand of trees within the particular geographic region and constructs a target pathway and/or a flight path, the remote computer system can execute Blocks of the method S100 to derive a specification (e.g., a pre-scan report, a visualization, a scan plan) for the scan order request. The remote computer system can then present the specification to the user within the user portal.

In one implementation, the remote computer system can: estimate a time window (e.g., a duration) for an operator carrying the mobile pack to execute the target pathway through the geographic region, collect optical and non-optical data of trees, via the mobile pack, while traversing along the target pathway; and manipulate these data to generate the set of target metric types associated with the scan type for the scan order prior to the target delivery date. Further, the remote computer system can access the scan path database, identify historical target pathways associated with a scan type corresponding to the particular scan type of this scan order, and estimate an average duration for an operator carrying the mobile pack to execute the target pathway for the particular scan type. The remote computer system can then identify a time window prior to the target delivery date, defined in the scan order request, according to the average duration.

Furthermore, the remote computer system can: access a set of environmental forecasts (e.g., weather conditions) for the geographic region for the time window prior to the target delivery date, from a weather database; extract a set of visual features representing terrain characteristics along the target pathway, from a region of the first stored image; derive an incline (e.g., a slope, a gradient) of a ground surface along the target pathway based on the second set of visual features; transform the set of environmental forecasts and the incline of the ground surface into a terrain quality, such as a numeric value or a rating (e.g., poor, medium, high); calculate a confidence score -such as a numeric value or percentage—representing a likelihood of completion of the target pathway by the operator during the time window and proportional to the terrain quality. Responsive to the confidence score exceeding a threshold confidence score, the remote computer system can: generate a predicted timeline for a series of events corresponding to the scan order; aggregate the target metric types, the predicted timeline, and the target pathway into a specification for the scan order; and render the specification for the scan order within the user portal.

In one variation, the remote computer system can execute Blocks of the method S100 to construct a target pathway defining navigation of an operator carrying a mobile pack for a stand of trees within a particular geographic region. The remote computer system can then: access the scan path database; identify a set of historical target pathways, annotated with durations, and associated with a scan type corresponding to the particular scan type of this scan order; and calculate an average duration for the operator carrying the mobile pack to execute the target pathway for the particular scan type based on the durations for the set of historical target pathways. The remote computer system can then identify a time window, such as a set of dates, prior to the target delivery date, defined in the scan order request, according to the average duration.

For example, the remote computer system can: access the scan path database; identify a first historical target pathway annotated with a first duration, such as three weeks, and associated with a scan type corresponding to a timber scan type of this scan order; identify a second historical target pathway annotated with a second duration, such as four weeks, and associated with the timber scan type; and identify a third historical target pathway annotated with a third duration, such as two weeks, and associated with the timber scan type. The remote computer system can then calculate an average duration, such as three weeks, for the operator carrying the mobile pack to execute the target pathway for the timber scan type based on the first duration, the second duration, and the third duration. The remote computer system can then identify a time window, such as between Mar. 8, 2024, and Mar. 29, 2024, prior to the target delivery date, such as Mar. 30, 2024, defined in the scan order request, according to the average duration, such as three weeks.

The remote computer system can then: access a rainfall condition, such as 10%, forecast for the geographic region during the time window (e.g., between Mar. 8, 2024, and Mar. 29, 2024); access a temperature condition, such as 62 degrees Fahrenheit, for the geographic region during the time window; and a visibility condition, such as 10 miles, for the geographic region during the time window. The remote computer system can: calculate a confidence score, such as 80%, for completion of the target pathway by the operator during the time window based on the rainfall condition, the temperature condition, and the visibility condition. Responsive to the confidence score, such as 80%, exceeding a threshold confidence score, such as 70%, the remote computer system can: generate a predicted timeline for the scan order; aggregate the set of target metric types, the predicted timeline, and the target pathway into a specification for the scan order; and render the specification for the scan order within the user portal.

Therefore, the remote computer system can generate a specification (e.g., a pre-scan report, a visualization, a scan plan) for the scan order and present the specification to the user within the user portal. The user may then review the set of target metric types, the predicted timeline, and the stored image and provide feedback prior to commencement of the scan order.

### 6.4.1 Nominal Condition+Predicted Timeline

In one variation, the remote computer system can: access a set of environmental forecasts from an environmental condition database (e.g., a weather database) corresponding to the geographic region; and define a nominal environmental condition for the geographic region based on the set of environmental forecasts. Then, based on the nominal condition, for each scan zone in the set of scan zones, the remote computer system can: define an operator and equipment (e.g., mobile pack, aerial vehicle, all-terrain vehicles) to scan trees in the scan zone; construct a target pathway defining navigation of the operator for the scan zone; define a first date and a time of arrival for the operator to arrive and commence a scan of trees in a first scan zone; define a second date for the operator to complete a scan of trees in a last scan zone; define a third date to collect and process data from the mobile pack for the scan order; and estimate a fourth date to extract the set of target metric types from the data. Further, the remote computer system can: estimate a duration between the first date and the fourth date; and assemble the first date, the time of arrival, the second date, the third date, the fourth date, and the duration into a predicted timeline for the scan order.

For example, the remote computer system can: access a set of environmental forecasts (e.g., rainfall, humidity, wind, visibility) corresponding to the geographic region during a first time period (e.g., one month); track this set of environmental forecasts during a future period of time (e.g., six months); calculate an average of each environmental condition in the set of environmental forecasts during the future period of time; and define a nominal condition for the geographic region—such as rainfall=10%, humidity=64%, wind=10 mph, visibility=10 miles—based on the average of each environmental condition. Then, based on this nominal condition, for a first scan zone in the set of scan zones, the remote computer system can: define an operator and equipment (e.g., mobile pack) to scan trees in the first scan zone; construct a target pathway defining navigation of the operator carrying the mobile pack for the first scan zone; estimate a first date and time of arrival, such as 9 AM on Mar. 8, 2024, for the operator to arrive and commence a scan of the first scan zone; define a second date, such as Mar. 15, 2024, for the operator to complete a scan of a last scan zone; estimate a third date, such as Mar. 16, 2024, to collect and process data from the mobile pack; and estimate a fourth date, such as Mar. 29, 2024, to extract the set of target metric types from the data. The remote computer system can then estimate a duration between the first date and the fourth date (e.g., 21 days, 504 hours).

The remote computer system can repeat these methods and techniques for each other scan zone in the set of scan zones and assemble the first date, the time of arrival, the second date, the third date, the fourth date, and the duration for each scan zone in the set of scan zones into a predicted timeline for the scan order. The remote computer system can then aggregate the predicted timeline, the set of target metric types, and the target pathway into a specification for the scan order.

### 6.4.2 Weather Condition Predictions

In another variation, the remote computer system can predict a set of weather conditions for the geographic region during time window based on historical weather conditions for historical time windows analogous to the time window. The remote computer system can then calculate a confidence score by simulating execution of the target pathway by the operator carrying the mobile pack within the time window according to the predicted set of weather conditions. Responsive to the confidence score falling below the threshold confidence score, the remote computer system can: estimate a new time window, prior to the first time window, for the operator carrying the mobile pack to execute the target pathway through the geographic region; predict a new set of weather conditions for the geographic region during the new time window; and calculate a new confidence score by simulating execution of the target pathway by the operator carrying the mobile pack within the new time window, according to the predicted set of weather conditions.

For example, based on historical weather conditions for historical time windows (e.g., between Mar. 8, 2023, and Mar. 29, 2023 or between Mar. 8, 2022, and Mar. 29, 2022) analogous to the time window (e.g., between Mar. 8, 2024, and Mar. 29, 2024), the remote computer system can: predict an ambient rainfall forecast, such as 50%, within the time window for the geographic region; predict an ambient temperature of air forecast, such as 60 degrees Fahrenheit, within the time window for the geographic region; and predict a visibility forecast, such as five miles, within the time window for the geographic region. The remote computer system can then transform the ambient rainfall forecast, ambient temperature of air, the visibility forecast, and the incline of the ground surface into a terrain quality; and calculate a confidence score, such as 68%, representing a likelihood of completion of the target pathway by the operator within the time window and proportional to the terrain quality.

Responsive to the confidence score, such as 68%, falling below the threshold confidence score, such as 70%, the remote computer system can: estimate a new time window—such as between Mar. 1, 2024, and Mar. 22, 2024 prior to the first time window—for the operator carrying the mobile pack to execute the target pathway through the geographic region; predict an initial set of environmental forecasts for the geographic region for the new time window; transform the initial set of environmental forecasts and the incline of the ground surface into a new terrain quality; calculate a new confidence score, such as 72%, for completion of the target pathway by the operator during the new time window and proportional to the new terrain quality; in response to the new confidence score, such as 72% exceeding the threshold confidence score, such as 70%, generate a predicted timeline for the scan order; aggregate the set of target metric types, the predicted timeline, and the target pathway into a specification for the scan order; and render the specification for the scan order within the user portal.

Therefore, the remote computer system can simulate execution of the target pathway by the operator carrying the mobile pack within varying time windows according to predicted weather conditions within each time window. Additionally, the remote computer system can: calculate a confidence score for each simulation representing a likelihood of execution of the target pathway by the operator during each time window; and, responsive to the confidence score exceeding a threshold score, generate a predicted timeline and a specification for the scan order.

### 6.4.3 Negative User Feedback of Specification+Visualization

Once the remote computer system serves the specification within the user portal, the user may approve or reject the predicted timeline, the set of target metric types, or the target pathway within the specification. Responsive to negative user feedback (e.g., rejection of the predicted timeline), the remote computer system receives the user feedback and executes Blocks of the method S100 to calculate a new predicted timeline for the scan order request.

In one variation, in response to receiving rejection of the first predicted timeline, the remote computer system can: receive a first set of user feedback associated with the specification depicting the first predicted timeline; access a second set of environmental forecasts for the geographic region during an initial time window, preceding the first time window, corresponding to the first set of user feedback; and calculate a new confidence score for completion of the target pathway by the operator during the initial time window based on the second set of environmental forecasts. Then, in response to the new confidence score exceeding the threshold confidence score, the remote computer system can: generate a new predicted timeline for the scan order corresponding to the new confidence score; assemble the set of target metric types, the new predicted timeline, and the target pathway into an updated specification for the scan order; and present the updated specification to the user within the user portal.

Therefore, the remote computer system can receive user negative feedback for the predicted timeline and estimate a new time window, prior to the target delivery date, for execution of the target pathway by the operator according to the negative user feedback. The remote computer system can: further present an updated specification to the user within the user portal that meets requirements of interest to the user; and, thereby, enable the user to achieve and maintain awareness of workers (e.g., an operator) entering and exiting the geographic region affiliated with the user.

### 6.4.4 Visualization

In one variation, the remote computer system can assemble the predicted timeline and the target metric types into a visualization for the scan order request and serve the visualization to the user within the user portal for review. Further, the remote computer system can: annotate the stored image with the array of scan zones; label each scan zone in the array of scan zones with a corresponding target metric in the set of target metric types; and transform the predicted timeline and the annotated stored image into a visualization for the scan order.

For example, the remote computer system can: assemble the set of target metric types and the predicted timeline into a first visualization for the scan order; and present the first visualization to the user within the user portal. Then, in response to receiving rejection of the first predicted timeline, the remote computer system can: receive a first set of user feedback associated with the first visualization depicting the first predicted timeline; access a second set of environmental forecasts for the geographic region during an initial time window, preceding the first time window, corresponding to the first set of user feedback; and calculate a new confidence score for completion of the target pathway by the operator during the initial time window based on the second set of environmental forecasts. Then, in response to the new confidence score exceeding the threshold confidence score, the remote computer system can: generate a new predicted timeline for the scan order for the series of events corresponding to the scan order; annotate the stored image with the array of scan zones; label each scan zone in the array of scan zones with a corresponding target metric in the set of target metric types;

transform the new predicted timeline and the annotated stored image into a second visualization for the scan order; and present the second visualization for the scan order to the user within the user portal.

Therefore, the remote computer system can: transform the predicted timeline and the annotated stored image into a visualization for the scan order; and present the visualization to the user within the user portal rather than presenting a pre-scan specification within the user portal.

6.5 Instructions for Entry into Geographic Region

In one implementation, upon generation of the target pathways and/or flight paths, the remote computer system can assign a set of instructions or access points (e.g., gates, bridges, roads, trails)—for operators to enter into and exit from a stand of trees within a particular geographic region—to each target pathway and/or flight path.

In one variation, the remote computer system can access a set of overhead images, depicting a stand of trees within the particular geographic region, from an aerial or satellite image database, as described above, and implement computer vision techniques to automatically detect a set of access points (e.g., gates, bridges, roads, trails) for an operator and/or aerial vehicle to enter into and exit from the stand of trees within the particular geographic region.

For example, the remote computer system can: access a set of aerial or satellite images depicting the particular geographic region based on the set of geospatial vertices predefined by the user in the request; extract a set of features from each image in the set of images representing the terrain of the particular geographic region (e.g., trees, rocks, shrubbery, drop-offs, inclines, bridges, roads, leaves, gates, trails); and detect a set of access points for each target pathway and/or flight path within the set of images based on the set of features. The remote computer system can then: access the set of environmental forecasts and characterize a weather quality of the environmental conditions. Then, in response to the weather quality exceeding a weather quality threshold, the remote computer system can: maintain the first set of access points for each target pathway and/or flight path; generate a prompt for the user to confirm the accessibility of the set of access points on the day of arrival to commence the scan of the set of target plots according to the specification; and serve the prompt to the user for confirmation with the specification via the user portal.

Alternatively, in response to the weather quality falling below the weather quality threshold, the remote computer system can update the dates for the specification.

For example, the remote computer system can: update the first date (e.g., Mar. 13, 2023) for the operator to arrive at the first target plot; update the time of arrival (e.g., 8 AM) for the operator to commence a cruise of the first target plot; update the second date (e.g., Mar. 15, 2023) succeeding the first date for the operator to complete the cruise of the first target plot; update the third date succeeding the second date to collect data from the mobile pack (e.g., Mar. 17, 2023); and define a fourth date succeeding the third date to process data and return metrics and insights corresponding to the scan order request (e.g., Mar. 24, 2023). The remote computer system can then: estimate the time interval based on a difference between the updated first date and the updated fourth date (e.g., 11 days, 264 hours); generate a prompt for the user to confirm the accessibility of the set of access points on the updated day of arrival to cruise the particular geographic region; and serve the prompt to the user for confirmation with the specification via the user portal.

In another variation, the user may manually define a set of instructions specifying entry into the geographic region, via an access point, within the scan order request. The remote computer system can then interface with the user portal to access the set of instructions and update the target pathway according to the set of instructions. Further, the remote computer system can prompt the user to define a set of instructions specifying entry into the geographic region within the user portal and, in response to receiving the set of instructions specifying entry into the geographic region within the user portal: write the set of instructions to the target pathway for the scan order; assemble the predicted timeline, the set of target metric types, and the target pathway into a specification for the scan order; and render the specification within the user portal.

For example, the remote computer system can interface with the user portal to receive a scan order request for a particular geographic region, such as a stand of trees within a woodland property. The remote computer system can then: generate a prompt requesting a set of instructions or an access point specifying entry for an operator into and exit from the stand of trees; and serve the prompt to the user within the user portal. The user may then define a set of instructions, such as a first instruction for an operator to navigate a private access road on the woodland property, a second instruction for the operator to locate a particular gate along the private access road, and a third instruction for the operator to enter into the stand of trees through the gate and lock the gate upon entry. Then, in response to receiving this set of instructions specifying entry into the stand of trees within the user portal, the remote computer system can: write the set of instructions to the target pathway for the scan order; assemble the predicted timeline, the set of target metric types, and the target pathway into a specification for the scan order; and render the specification within the user portal.

Therefore, during the setup period, the remote computer system can autonomously detect a set of access points for an operator and/or aerial vehicle to enter into and exit from a stand of trees to execute a target pathway and/or flight path. Alternatively, the remote computer system can prompt the user to manually define a set of instructions specifying entry into and exit from the stand of trees and update the target pathway and/or flight path with the set of instructions defined by the user.

### 7. Certified Operator

In one implementation, once the remote computer system serves the specification within the user portal, the user may confirm or reject the predicted timeline, the set of target metric types, or the target pathway within the specification. Responsive to positive user feedback (e.g., confirmation of the predicted timeline), the remote computer system can: access a credential, such as a regulation, a certification, or a license, required for operators completing scans, associated with the sampling type, within the geographic region; identify a certified operator to execute the target pathway according to the credential; assign this operator to the target pathway; and present the target pathway, annotated with instructions specifying entry into and exit from the geographic region, within an operator portal, as shown in FIGS. 2B and 2C.

In one variation, responsive to confirmation of the predicted timeline, the remote computer system can access a credential, associated with the geographic region, for an operator to execute the target pathway from a regulatory forestry database. The remote computer system can then: scan an operator database for a set of operators located within a threshold distance of the geographic region; identify an operator profile, in a set of operator profiles, affiliated with a first operator certified according to the credential;

and access a set of operator characteristics—including a time interval representing availability of the first operator to complete a scan within the geographic region -specified by the operator profile, and, responsive to the time window intersecting the time interval, assign the operator to the target pathway for the scan order.

For example, in response to receiving confirmation of the specification within the user portal, the remote computer system can: access a credential required for operators completing scans associated with a timber scan type, within the geographic region, such as a forest in California; scan an operator database for a set of operators located within a threshold distance (e.g., 25 miles, 50 miles, 100 miles) of the geographic region; identify an operator profile, in a set of operator profiles, affiliated with a first operator certified according to the credential; and access a set of operator characteristics—including a time interval representing availability of the first operator to complete a scan within the geographic region and a set of contact information (e.g., name, phone number, experience, company affiliation) assigned to the operator—specified by the operator profile. Then, in response to the time window intersecting the time interval, the remote computer system can: assign the operator to the target pathway for the scan order;

update the specification with the set of contact information; and render the target pathway within an operator portal for completion by the first operator.

Alternatively, in response to the time window falling outside of the time interval, the remote computer system can: define a new time window intersecting the time interval; access a new set of environmental forecasts for the geographic region during the second window; transform the new set of environmental forecasts and the incline of the ground surface into a new terrain quality; and calculate a new confidence score for completion of the target pathway by the first operator, during the new time window, and proportional to the new terrain quality. Responsive to the new confidence score exceeding the threshold confidence score, the remote computer system can: generate a new predicted timeline for the series of events corresponding to the scan order; append the specification with the new predicted timeline; generate a notification to alert the user of delay for the scan order; and serve the notification and the specification within the user portal.

Therefore, the remote computer system can assign an operator certified according to a credential that corresponds to regulatory requirements of the geographic region and the particular scan type. The remote computer system can also serve the specification within the user portal to enable the user to access the contact information of the operator in the event of an emergency or to provide new instructions for entry into and exit from the geographic region.

### 7.1 Absence of Certified Operator+Operator Portal

In one variation, responsive to absence of an operator exhibiting a set of credentials associated with the geographic region and the particular scan type, the remote computer system can: access the operator database and scan operator profiles affiliated with operators occupying locations proximal (e.g., within a threshold distance of) the geographic region; select an operator nearest the geographic region; and present the set of credentials to this operator within an operator portal. Responsive to completion of the set of credentials by the operator, the remote computer system can: assign the operator to the target pathway for the scan order; and present the specification within the user portal.

For example, the remote computer system can: access a set of credentials—including a first subset of credentials corresponding to a carbon sequestration scan type—associated with the geographic region, such as Washington; access the operator database; and scan the operator database for an operator profile including a second set of credentials corresponding to the first subset of credentials. Then, in response to detecting absence of an operator profile including the second set of credentials corresponding to the first subset of credentials, the remote computer system can: select an operator profile, from the operator database, affiliated with an operator occupying a first location within a threshold distance of the geographic region; and present the first subset of credentials to the second operator within an operator portal. Responsive to receiving completion of the first subset of credentials by the operator, the remote computer system can assign the operator to the target pathway for the scan order; and serve the specification and the set of instructions within the operator portal for execution by the operator.

Therefore, responsive to absence of a certified operator within the operator database, the remote computer system can identify an operator nearest (e.g., within a threshold distance of) the geographic region and present the set of credentials for the scan order in the operator portal to enable the operator to complete the set of credentials. The remote computer system can then assign the certified operator to the target pathway for the scan order.

### 8. In-Process Scan Feedback+Scan Order Status Notifications

Once the user (e.g., customer, administrator, manager affiliated with the particular geographic region) approves the specification and confirms availability of the set of access points, the remote computer system can initiate the specification to dispatch the set of operators and/or the set of aerial vehicles to a stand of trees within the particular geographic region. Further, the remote computer system can implement methods and techniques described in U.S. patent application Ser. No.18/391,393, filed on 20 Dec. 2023, to characterize a quality of data and generate status update notifications according to the quality of data.

In one variation, during a scan of trees in a first scan zone, the remote computer system can: receive optical data (e.g., low-resolution images) and non-optical data (e.g., ambient data, geospatial data, deviations) from the local controller in the mobile pack carried by an operator and/or from the wireless communications module in an aerial vehicle; and characterize a quality of these data. Then, in response to the quality of these data exceeding a quality threshold, the remote computer system can: generate a status update notification showing the specification as “on-time”; and present this status update notification to the user via the user portal.

Alternatively, in response to the quality of these data falling below the quality threshold, the remote computer system can generate a notification indicating re-traversal of this scan zone by the operator and/or aerial vehicle. The remote computer system can then implement methods and techniques described above to: estimate a time interval for each operator and/or aerial vehicle to repeat the scan of the target plot; generate a status update notification indicating delay of the specification; and present this status update notification to the user via the user portal.

For example, the remote computer system can: construct the target pathway, defining navigation of the operator carrying a mobile pack, based on a scan profile; access a first sequence of images—annotated with locations and timestamps—of the mobile pack while the user traverses along the target pathway; derive a timeseries trajectory of the operator carrying the mobile pack based on locations and timestamps of the mobile pack; and detect a difference between the timeseries trajectory of the operator and the predicted timeline for the scan order. Then, in response to the difference exceeding a threshold difference, the remote computer system can: generate a notification to alert the user of delay in the predicted timeline for the scan order and serve the notification within the user portal.

In another variation, during a scan of trees in a first scan zone and a second scan zone, the remote computer system can: receive optical data (e.g., low-resolution images) and non-optical data (e.g., ambient data, geospatial data, deviations) from the local controller in the mobile pack carried by the operator and/or from the wireless communications module in an aerial vehicle; derive metrics corresponding to the target metric types of interest to the user as defined in the scan order request; and present these metrics to the user via the user portal.

For example, the remote computer system can dispatch an operator carrying a mobile pack to the geographic region and transmit the target pathway to the mobile pack for completion by the operator. The remote computer system can then: access a first sequence of images, representing a first set of trees in a first scan zone, captured by a set of optical sensors arranged in the mobile pack while the operator navigates along a first segment of the target pathway proximal the first scan zone; access a second sequence of images, representing a second set of trees in a second scan zone, captured by the set of optical sensors while the operator navigates along a second segment of the target pathway proximal the second scan zone; extract a second set of visual features, representing a first set of heights of the first set of trees, from the first sequence of images; extract a third set of visual features, representing a first set of base diameters of the first set of trees, from the second sequence of images; calculate a tree-base-to-height ratio based on a first combination of the first set of heights and a second combination of the first set of diameters; and present the tree-base-to-height ratio within the user portal.

Therefore, the remote computer system can generate status update notifications and provide these status update notifications to the user and enable the user to monitor the progress of the scan order in real-time. Further, the remote computer system can derive metrics from optical data and non-optical data collected during a scan and present these metrics to the user within the user portal.

### 9. Post-Scan: Mapping and Metrics

Once the scan for each target plot is complete, the remote computer system can: receive optical data (e.g., high resolution color images) depicting each target plot within a stand of trees from the local controller arranged in the mobile pack and/or the wireless communications module arranged in the aerial vehicle; and stitch these color images into a composite (e.g., panoramic) color image of the stand of trees. The remote computer system can then implement these methods and techniques for each other stand of trees within the particular geographic region—designated by the user in the scan order request—to stitch these other color images into a composite color image of the particular geographic region. Additionally, the remote computer system can annotate the composite color image of the particular geographic region with environmental conditions and geospatial location data to generate a two-dimensional map of the geographic region; and present this two-dimensional map to the user.

In one implementation, the remote computer system can execute this process after the scan is complete (i.e., post-scan) for each target plot to generate and develop a three-dimensional representation of the stand of geographic region. In this implementation, the remote computer system can: collect optical data and depth data from the local controller arranged in the mobile pack and/or the wireless communications module arranged in the aerial vehicle; execute simultaneous localization and mapping (or “SLAM”) techniques to generate a two-dimensional map of each stand of trees based on the depth data; and develop a three-dimensional representation of the particular geographic region based on the two-dimensional map of each stand of trees and the optical data.

Furthermore, the remote computer system can extract metrics and insights from this three-dimensional representation; and present this three-dimensional representation to the user on the date according to the specification, thereby enabling the user to review insights and metrics for the particular geographic region.

### 9.1 Metrics for Scan Order

In one variation, the remote computer system can extract metrics and insights from this three-dimensional representation of the particular geographic region according to the metrics and insights designated by the user in the scan order request.

In one example, upon completion of a scan for each target plot, the remote computer system extracts a gross tree count and a type of each tree in the gross tree count for the particular geographic region. In this example, the remote computer system accesses a set of images—depicting a first target plot—captured by a set of sensors arranged within the mobile pack and/or arranged in the aerial vehicle and annotated with non-optical data from the three-dimensional representation. The remote computer system then: identifies a particular tree species within the first target plot; accesses a set of template characteristics associated with a tree type; and implements computer vision techniques (e.g., template matching) to match features of the particular tree to a set of template characteristics associated with a tree type. In response to the features of the particular tree matching the template characteristics within a matching threshold, the remote computer system assigns the tree type associated with the template characteristics to the particular tree. The remote computer system then repeat these methods and techniques for each other particular tree within the three-dimensional representation to assign a tree type. Additionally, the remote computer system extracts a gross tree count from the three-dimensional representation of the particular geographic region and present these metrics to the user (e.g., customer, administrator, manager) on the return date defined in the predicted timeline, as described above.

Therefore, the remote computer system can extract raw metrics corresponding to the stand of trees, extrapolate other metrics from the three-dimensional representation to identify additional characteristics of the stand of trees and assign these metrics to particular trees within the three-dimensional representation. The remote computer system can then present the three-dimensional representation to the user (e.g., owner or manager affiliated with the geographic region) on the date according to the specification, and thereby enable the user to timely review metrics—designated in the scan order request—upon completion of the scan order (e.g., post-scan).

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a scan order for a geographic region via a user portal, the scan order defining:
a geospatial boundary for the geographic region; and
a target delivery date for execution of the scan order;
accessing a first stored image depicting the geographic region;
projecting the geospatial boundary onto the first stored image;
extracting a first set of visual features representing a stand of trees, within the geospatial boundary, from the first stored image;
predicting a first scan type, in a set of scan types, for the stand of trees:
based on historical scan profiles of geographic regions analogous to the geographic region; and
based on the first set of visual features;
retrieving a first scan profile, from a set of scan profiles, corresponding to the first scan type and specifying a set of target metric types associated with the first scan type;
based on the first scan profile, constructing a target pathway, within the stand of trees, traversable by a first operator;
accessing a first set of environmental forecasts for the geographic region within a first time window prior to the target delivery date;
extracting a second set of visual features representing terrain characteristics along the target pathway, from a region of the first stored image;
deriving an incline of a ground surface along the target pathway based on the second set of visual features;
transforming the set of environmental forecasts and the incline of the ground surface into a terrain quality;
calculating a first confidence score for completion of the target pathway by the operator, during the first time window, proportional to the terrain quality; and
in response to the first confidence score exceeding a threshold confidence score:
generating a predicted timeline for a series of events corresponding to the scan order;
aggregating the target metric types, the predicted timeline, and the target pathway into a specification for the scan order; and
rendering the specification for the scan order within the user portal.

2. The method of claim 1:
wherein predicting the first scan type for the stand of trees comprises predicting the first scan type, comprising a timber scan type, based on historical scan profiles of geographic regions analogous to the geographic region;
wherein retrieving the first scan profile from the set of scan profiles comprises retrieving the first scan profile from the set of scan profiles corresponding to the timber scan type and comprising:
an array of scan zones associated with the timber scan type;
a first target metric type, in the set of target metric types, representing base diameters of the stand of trees;
a second target metric type, in the set of target metric types, representing heights of the stand of trees; and
a third target metric type, in the set of target metric types, representing a tree-base-to-height-ratio of the stand of trees;
further comprising:
projecting the array of scan zones onto the first region of the first stored image; and
for each scan zone in the array of scan zones:
defining a minimum radius within a target radius range for the scan zone;
defining a first distance from a center of the scan zone for an outer scan path based on the minimum radius; and
defining a second distance from the center of the scan zone, less than the first distance, for an inner scan path;
wherein constructing the target pathway comprises aggregating minimum radii, outer scan paths, and inner scan paths into a target pathway intersecting the array of scan zones, traversable by the operator carrying a mobile pack, for the geographic region; and
wherein aggregating the target metric types, the predicted timeline, and the target pathway, into the specification comprises aggregating the first target metric type, the second target metric type, the third target metric type, the predicted timeline, and the target pathway into the specification for the scan order.

3. The method of claim 2, further comprising:
during a first time period:
dispatching the operator carrying a mobile pack to the geographic region; and
transmitting the target pathway to the mobile pack for completion by the operator; and
during a second time period, at a computer system:
accessing a first sequence of images, representing a first set of trees in a first scan zone, captured by a set of optical sensors arranged in the mobile pack while the operator navigates along a first segment of the target pathway proximal the first scan zone;
accessing a second sequence of images, representing a second set of trees in a second scan zone, captured by the set of optical sensors while the operator navigates along a second segment of the target pathway proximal the second scan zone;
extracting a second set of visual features, representing a first set of heights of the first set of trees, from the first sequence of images;
extracting a third set of visual features, representing a first set of base diameters of the first set of trees, from the second sequence of images; and
calculating a tree-base-to-height ratio based on a first combination of the first set of heights and a second combination of the first set of diameters.

4. The method of claim 1:
wherein extracting the first set of visual features comprises extracting the first set of visual features, representing utility characteristics of a first set of power lines proximal the stand of trees, from the first stored image;
wherein predicting the first scan type for the stand of trees comprises predicting the first scan type, comprising a utility scan type, based on historical scan profiles of geographic regions analogous to the geographic region and based on the first set of visual features;
wherein retrieving the first scan profile from the set of scan profiles comprises retrieving the first scan profile, from the set of scan profiles, corresponding to the utility scan type and comprising:
an array of scan zones associated with the utility scan type;
a first target metric type, in the set of target metric types, representing a quantity of trees within a threshold distance of the first set of power lines;
a second target metric type, in the set of target metric types, representing a set of canopy characteristics of trees within the threshold distance of the first set of power lines; and
a third target metric type, in the set of target metric types, representing a fire risk of trees within the threshold distance of the first set of power lines;
wherein constructing the target pathway comprises:
for each scan zone in the array of scan zones:
defining a first orientation for a first pathway across the scan zone;
defining a second orientation orthogonal to the first orientation for a second pathway across the scan zone; and
defining a third orientation orthogonal to the second orientation and opposite the first pathway for a third pathway across the scan zone; and
aggregating pathways into a boustrophedonic target pathway, traversable by the operator, for the geographic region; and
wherein aggregating the target metric types, the predicted timeline, and the target pathway, into the specification comprises aggregating the first target metric type, the second target metric type, the predicted timeline, and the boustrophedonic target pathway into the specification for the scan order.

5. The method of claim 1:
wherein predicting the first scan type for the stand of trees comprises predicting the first scan type, comprising a carbon sequestration scan type, based on historical scan profiles of geographic regions analogous to the geographic region;
wherein retrieving the first scan profile from the set of scan profiles comprises retrieving the first scan profile, from the set of scan profiles, corresponding to the carbon sequestration scan type and comprising:
a first target metric type, in the set of target metric types, representing a total quantity of trees in the stand of trees;
a second target metric type, in the set of target metric types, representing base diameters of the stand of trees; and
a third target metric type, in the set of target metric types, representing a volume of carbon captured by the stand of trees; and
wherein aggregating the target metric types, the predicted timeline, and the target pathway into the specification comprises aggregating the first target metric type, the second target metric type, the third target metric type, the predicted timeline, and the target pathway into the specification for the scan order.

6. The method of claim 1, further comprising:
in response to receiving confirmation of the specification within the user portal:
accessing a first credential required for operators completing scans, associated with the first scan type, within the geographic region;
scanning an operator database for a set of operators located within a threshold distance of the geographic region; and
identifying an operator profile, in a set of operator profiles, affiliated with a second operator, in the set of operators, certified according to the first credential;
accessing a set of operator characteristics specified by the operator profile, the set of operator characteristics comprising:
a time interval representing availability of the first operator to complete a scan within the geographic region; and
a first set of contact information corresponding to the second operator; and
in response to the first time window intersecting the time interval:
assigning the second operator to the target pathway within the specification for the scan order;
updating the specification with the first set of contact information; and
rendering the target pathway within an operator portal for completion by the second operator.

7. The method of claim 6:
wherein accessing the scan order for the geographic region comprises accessing the scan order for the geographic region via the user portal, the scan order defining:
a first instruction, in a set of instructions, specifying an access road for entry into the geographic region in the user portal;
a second instruction, in the set of instructions, specifying a first gate for entry into the stand of trees within the geographic region in the user portal; and
a third instruction, in the set of instructions, specifying a second gate for the operator to exit from the stand of trees within the geographic region in the user portal; and
wherein rendering the target pathway within the operator portal comprises rendering the target pathway and the set of instructions within the operator portal for completion by the second operator.

8. The method of claim 6:
further comprising, in response to the first time window falling outside of the time interval:
defining a second time window intersecting the time interval;
accessing a second set of environmental forecasts for the geographic region during the second window;
transforming the second set of environmental forecasts and the incline of the ground surface into a second terrain quality; and
calculating a second confidence score for completion of the target pathway by the second operator during the second time window proportional to the second terrain quality; and
in response to the second confidence score exceeding the threshold confidence score:
generating a second predicted timeline for the series of events corresponding to the scan order;
appending the specification with the second predicted timeline;
generating a notification to alert the user of delay for the scan order; and
serving the notification and the specification within the user portal.

9. The method of claim 1, further comprising:
in response to receiving rejection of the first predicted timeline:
receiving a first set of user feedback associated with the specification depicting the first predicted timeline;
accessing an initial set of environmental forecasts for the geographic region during an initial time window, preceding the first time window, corresponding to the first set of user feedback;
transforming the initial set of environmental forecasts and the incline of the ground surface into an initial terrain quality; and
calculating a second confidence score for completion of the target pathway by the second operator during the initial time window, proportional to the initial terrain quality; and
in response to the second confidence score exceeding the threshold confidence score:
generating a second predicted timeline for the series of events corresponding to the scan order;
assembling the set of target metric types, the second predicted timeline, and the target pathway into a second specification for the scan order; and
presenting the second specification to the user within the user portal.

10. The method of claim 9:
wherein aggregating the target metric types, the predicted timeline, and the target pathway into the specification for the scan order comprises assembling the set of target metric types and the first predicted timeline into a first visualization for the scan order;
wherein rendering the specification for the scan order within the user portal comprises presenting the first visualization to the user within the user portal;
wherein receiving the first set of user feedback associated with the specification comprises receiving the first set of user feedback associated with the first visualization depicting the first predicted timeline, in response to receiving rejection of the first predicted timeline;
wherein assembling the set of target metric types and the second predicted timeline into the second specification comprises assembling the set of target metric types and the second predicted timeline into a second visualization for the scan order, in response to the second confidence score exceeding the threshold confidence score; and
wherein presenting the second specification to the user within the user portal comprises rendering the second visualization to the user within the user portal.

11. The method of claim 1:
wherein accessing the first set of environmental forecasts for the geographic region for the first time window prior to the target delivery date comprises, based on historical weather conditions for time windows analogous to the first time window:
predicting an ambient rainfall forecast within the first time window for the geographic region;
predicting an ambient temperature of air forecast within the first time window for the geographic region; and
predicting a visibility forecast within the first time window for the geographic region; and
wherein transforming the set of environmental forecasts and the incline of the ground surface into the terrain quality comprises transforming the ambient rainfall forecast, ambient temperature of air, the visibility forecast, and the incline of the ground surface into the terrain quality.

12. The method of claim 1:
wherein retrieving the first scan profile, from the set of scan profiles comprises retrieving the first scan profile, from the set of scan profiles, corresponding to the first scan type and defining:
an array of scan zones associated with the first scan type; and
the set of target metric types for the array of scan zones;
further comprising:
projecting the array of scan zones onto the first region of the first stored image depicting the stand of trees, each scan zone in the array of scan zones:
defining a minimum diameter within a target diameter range for the scan zone;
defining a lateral pitch distance greater than the minimum diameter and less than a maximum width of the geospatial boundary; and
defining a longitudinal pitch distance greater than the minimum diameter and less than a maximum length of the of the geospatial boundary; and
wherein constructing the target pathway comprises constructing the target pathway intersecting the array of scan zones, traversable by the operator, for the geographic region based on the scan profile and based on the first stored image.

13. The method of claim 12:
wherein accessing the first stored image depicting the geographic region comprises:
accessing an image database comprising overhead images captured by an aerial vehicle; and
selecting the first stored image, comprising a first overhead image depicting the geographic region, from the image database;
further comprising extracting the second set of visual features from a first subregion, in the first region, of the first overhead image representing tree characteristics of a first set of trees; and
wherein projecting the array of scan zones onto the first region of the first stored image depicting the stand of trees comprises projecting a first scan zone, in the array of scan zones, onto the first subregion, in the first region, of the overhead image to encompass the first set of trees.

14. The method of claim 1:
wherein constructing the target pathway comprises constructing the target pathway, within the stand of trees, traversable by the operator carrying a mobile pack, based on the first scan profile; and
further comprising:
accessing a first sequence of images from the mobile pack, the first sequence of images annotated with locations and timestamps of the mobile pack;
deriving a timeseries trajectory of the operator carrying the mobile pack based on locations and timestamps of the mobile pack;
detecting a difference between the timeseries trajectory of the operator and the first predicted timeline for the scan order; and
in response to the difference exceeding a threshold difference:
generating a notification to alert the user of delay in the first predicted timeline for the scan order; and
serving the notification within the user portal.

15. A method comprising:
during a first time period:
accessing a scan order for a geographic region, the scan order defining a target delivery date for execution of the scan order;
accessing a first stored image depicting the geographic region;
predicting a scan type, in a set of scan types, for the geographic region based on visual features detected in the first stored image;
accessing a set of target metric types corresponding to the scan type;
constructing a target pathway within the geographic region based on the set of target metric types and based on the first stored image;
accessing a set of environmental forecasts for the geographic region during a time window prior to the target delivery date;
calculating a confidence score for completion of the target pathway based on the set of environmental forecasts; and
in response to the confidence score exceeding a threshold confidence score:
generating a predicted timeline for a series of events corresponding to the scan order; and
rendering the predicted timeline within a user portal; and
during a second time period:
in response to receiving confirmation of the predicted timeline:
accessing a first credential required for operators completing scans, associated with the sampling type, within the geographic region;
scanning an operator database for a set of operators located within a threshold distance of the geographic region;
identifying an operator profile, in a set of operator profiles, affiliated with a first operator, in the set of operators, certified according to the first credential; and
accessing a set of operator characteristics specified by the operator profile, the set of operator characteristics comprising a time interval representing availability of the first operator to complete a scan within the geographic region; and
in response to the first time window intersecting the time interval, assigning the first operator to the target pathway for the scan order.

16. The method of claim 15, further comprising, during the second time period:
prompting the user to define a set of instructions specifying entry into the geographic region within the user portal; and
in response to receiving the set of instructions specifying entry into the geographic region within the user portal:
writing the set of instructions to the target pathway for the scan order;
assembling the predicted timeline, the set of target metric types, and the target pathway into a specification for the scan order; and
serving the specification and the set of instructions within an operator portal for execution by the first operator.

17. The method of claim 15:
wherein predicting the scan type for the geographic region based on visual features detected in the first stored image comprises predicting the scan type, comprising a timber scan type, based on historical scan profiles of geographic regions analogous to the geographic region; and
wherein accessing the first credential required for operators completing scans, associated with the sampling type, within the geographic region comprises accessing the first credential required for operator completing scans, associated with the timber sampling type, within the geographic region.

18. The method of claim 15:
wherein accessing the set of operator characteristics specified by the operator profile comprises accessing the set of operator characteristics specified by the operator profile, the set of operator characteristics comprising a first set of contact information corresponding to the first operator; and
wherein assigning the first operator to the target pathway comprises in response to the first time window intersecting the time interval:
rendering the target pathway within an operator portal for completion by the first operator;
assembling the predicted timeline, the target pathway, and the first set of contact information into a specification for the scan order; and
serving the specification within the user portal.

19. A method comprising:
accessing a scan order for a geographic region, the scan order defining:
a scan type for the geographic region; and
a target delivery date for execution of the scan order;
accessing a first stored image depicting the geographic region;
based on a set of visual features detected in the first stored image:
identifying a stand of trees within the geographic region; and
predicting a scan type, in a set of scan types, for the stand of trees in the first stored image;
retrieving a scan profile, from a set of scan profiles, corresponding to the scan type and specifying a set of target metric types associated with the scan type;
based on the scan profile, constructing a target pathway, within the stand of trees, traversable by an operator;
accessing a set of environmental forecasts for the geographic region within a time window preceding the target delivery date;
calculating a confidence score for completion of the target pathway by the operator based on the set of environmental forecasts; and
in response to the confidence score exceeding a threshold confidence score, generating a predicted timeline for a series of events corresponding to the scan order.

20. The method of claim 19:
wherein accessing the scan order for the geographic region comprises receiving the scan order for the geographic region at a user portal, the scan order defining a geospatial boundary for the geographic region; and
wherein identifying the stand of trees within the geographic region comprises:
projecting the geospatial boundary onto the first stored image;
extracting the set of visual features from the first stored image; and
based on the first set of visual features, predicting the scan type for the stand of trees in the first stored image.
